(19) United States
(12) Patent Application Publication
(10) Pub. No.: US 2025/0043121 A1
(43) Pub. Date: Feb. 6, 2025

(54) PROPYLENE BASED POLYMER COMPOSITION

(71) Applicant: Basell Poliolefine Italia S.r.l., Milano (IT)

(72) Inventors: Monica Galvan, Ferrara (IT); Michele Grazzi, Ferrara (IT); Marco Ciarafoni, Ferrara (IT); Alessia Di Capua, Ferrara (IT); Lelio Basile, Ferrara (IT)

(73) Assignee: Basell Poliolefine Italia S.r.l., Milano (IT)

(21) Appl. No.: 18/718,274

(22) PCT Filed: Nov. 29, 2022
(86) PCT No.: PCT/EP2022/083620

§ 371 Date: Jun. 10, 2024

(30) Foreign Application Priority Data
Dec. 14, 2021 (EP) 21214227.7

(51) Int. Cl. C08L 23/14; C08J 5/18

(52) U.S. Cl. CPC C08L 23/14; C08J 5/18; C08J 2323/14; C08J 2423/14; C08L 2201/10; C08L 2203/162; C08L 2205/03

(57) ABSTRACT

A propylene polymer composition made from or containing
a) from 20 wt % to 44 wt % of a propylene 1-hexene copolymer, containing from 5.0 wt % to 8.3 wt % of 1-hexene derived units,
b) from 25 wt % to 45 wt % of a propylene 1-hexene ethylene terpolymer, and
c) from 25 wt % to 50 wt % of a propylene ethylene copolymer,
   wherein the Melt Flow Rate of components a)+b)+c) is from 3.5 to 12.0 g/10 min.

### FIELD OF THE INVENTION

In general, the present disclosure relates to the field of chemistry. More specifically, the present disclosure relates to polymer chemistry. In particular, the present disclosure relates to a composition made from or containing a copolymer of propylene with 1-hexene and a copolymer of propylene and ethylene and films made therefrom.

### BACKGROUND OF THE INVENTION

In some instances, copolymers of propylene and 1-hexene have a molecular weight distribution of monomodal type and are used for pipes systems.

In some instances, a copolymer of propylene with 1-hexene and a copolymer of propylene and ethylene are used for films, including biaxially oriented polypropylene films (BOPP) and cast films having a low seal initiation temperature (SIT) and high transparency.

### SUMMARY OF THE INVENTION

In a general embodiment, the present disclosure provides a propylene polymer composition made from or containing:
a) from 20 wt % to 44 wt % of a propylene 1-hexene copolymer, containing from 5.0 wt % to 8.3 wt % of 1-hexene derived units and having a Melt Flow Rate (MFR, measured according to ISO 1133, 230° C./2.16 kg, that is, at 230° C., with a load of 2.16 kg) from 3.5 to 8.5 g/10 min;
b) from 25 wt % to 45 wt % of a propylene 1-hexene ethylene terpolymer, containing from 7.2 to 12.0% by weight of 1-hexene derived units and from 0.5 to 2.5 wt % of ethylene derived units,
wherein the Melt Flow Rate (MFR, measured according to ISO 1133, 230° C./2.16 kg, that is, at 230° C., with a load of 2.16 kg) of components a)+b) is from 3.5 to 8.5 g/10 min; and
c) from 25 wt % to 50 wt % of a propylene ethylene copolymer, containing from 3.5 wt % to 8.7 wt % of ethylene derived units,
wherein the Melt Flow Rate (MFR, measured according to ISO 1133, 230° C./2.16 kg, that is, at 230° C., with a load of 2.16 kg) of components a)+b)+c) is from 3.5 to 12.0 g/10 min;
the sum of the amount of a), b), and c) being 100;
wherein:
i) the xylene soluble content at 25° C. of the propylene polymer composition ranges from 16.4 wt % to 35.3 wt %; and
ii) the melting point of the propylene polymer composition ranges from 122° C. to 132° C.

### DETAILED DESCRIPTION OF THE INVENTION

In some embodiments, the present disclosure provides a propylene polymer composition made from or containing:
a) from 20 wt % to 44 wt %, alternatively from 27 wt % to 40 wt %, alternatively from 29 wt % to 35 wt %, of a propylene 1-hexene copolymer, containing from 5.0 wt % to 8.3 wt %, alternatively from 6.3 wt % to 7.8 wt %, alternatively from 6.5 wt % to 7.4 wt %, of 1-hexene derived units and having a Melt Flow Rate (MFR, measured according to ISO 1133, 230° C./2.16 kg, that is, at 230° C., with a load of 2.16 kg) from 3.5 to 8.5 g/10 min, alternatively from 4.4 to 8.0 g/10 min, alternatively from 5.0 to 7.0 g/10 min;
b) from 25 wt % to 45 wt %, alternatively from 35 wt % to 40 wt %, alternatively from 36 wt % to 39 wt %, of a propylene 1-hexene ethylene terpolymer, containing from 7.2 wt % to 12.0 wt %, alternatively from 7.5 wt % to 9.5 wt %, alternatively from 8.2 wt % to 9.1 wt %, of 1-hexene derived units and from 0.5 wt % to 2.5 wt %, alternatively from 0.7 wt % to 2.2 wt %, alternatively from 0.8 wt % to 2.0 wt %, of ethylene derived units;
wherein the Melt Flow Rate (MFR, measured according to ISO 1133, 230° C./2.16 kg, that is, at 230° C., with a load of 2.16 kg) of components a)+b) is from 3.5 to 8.5 g/10 min, alternatively from 4.4 to 8.0 g/10 min, alternatively from 5.0 to 7.0 g/10 min; and
c) from 25 wt % to 50 wt %, alternatively from 27 wt % to 40 wt %, alternatively from 29 wt % to 35 wt %, of a propylene ethylene copolymer, containing from 3.5 wt % to 8.7 wt %, alternatively from 4.5 wt % to 8.4 wt %, alternatively from 4.8 wt % to 8.1 wt %, of ethylene derived units,
wherein the Melt Flow Rate (MFR, measured according to ISO 1133, 230° C./2.16 kg, that is, at 230° C., with a load of 2.16 kg) of components a)+b)+c) is from 3.5 to 12.0 g/10 min, alternatively from 4.4 to 8.0 g/10 min, alternatively from 5.0 to 8.5 g/10 min;
the sum of the amount of a), b) and c) being 100;
wherein:
i) the xylene soluble content at 25° C. of the propylene polymer composition ranges from 16.4 wt % to 35.3 wt %, alternatively from 18.3 wt % to 30.1 wt %, alternatively from 22.1 wt % to 28.3 wt %; and
ii) the melting point of the propylene polymer composition ranges from 122° C. to 132° C., alternatively from 125° C. to 131° C., alternatively from 126° C. to 130° C.

In some embodiments, the propylene 1-hexene copolymer contains propylene and 1-hexene derived units, in the absence of other olefin-derived units. In some embodiments, the propylene ethylene copolymer contains propylene and ethylene derived units, in the absence of other olefin-derived units. The propylene 1-hexene ethylene terpolymer contains propylene, 1-hexene, and ethylene derived units, in the absence of other olefin-derived units.

In some embodiments, the propylene polymer composition is used for the production of film, alternatively cast or biaxially oriented polypropylene films (BOPP) films. In some embodiments, the present disclosure provides a film made from or containing the propylene polymer composition. In some embodiments, the film is selected from the group consisting of cast films and biaxially oriented polypropylene films (BOPP) films.

In some embodiments, the Seal Initiating Temperature (SIT) value is between 70° C. and 85° C.; alternatively between 75° C. and 82° C. In some embodiments, the difference between the melting point and the SIT (Tm-SIT) ranges from 45° C. to 60° C.; alternatively from 46° C. to 58° C.

In some embodiments, the propylene polymer composition has a haze value, measured on BOPP film, lower than 0.90%, alternatively lower than 0.80%, alternatively lower than 0.78. In some embodiments, the haze is higher than 0.20%.

In some embodiments, the process for preparing the propylene ethylene copolymer is carried out in the presence of a highly stereospecific heterogeneous Ziegler-Natta catalyst. In some embodiments, the Ziegler-Natta catalysts are made from or containing a solid catalyst component made from or containing a titanium compound having a titanium-halogen bond and an electron-donor compound (internal donor), both supported on magnesium chloride. In some embodiments, the Ziegler-Natta catalysts systems are further made from or containing an organo-aluminum compound as a co-catalyst and optionally an external electron-donor compound.

In some embodiments, the catalysts systems are as described in the European Patent Nos. EP45977, EP361494, EP728769, and EP 1272533 and Patent Cooperation Treaty Publication No. W000163261.

In some embodiments, the organo-aluminum compound is an alkyl-Al compound. In some embodiments, the alkyl-Al compound is selected from trialkyl aluminum compounds. In some embodiments, the trialkyl aluminum compounds are selected from the group consisting of triethylaluminum, triisobutylaluminum, tri-n-butylaluminum, tri-n-hexylaluminum, and tri-n-octylaluminum. In some embodiments, mixtures of trialkylaluminums with alkylaluminum halides, alkylaluminum hydrides, or alkylaluminum sesquichlorides are used. In some embodiments, alkylaluminum sesquichlorides are selected from the group consisting of AlEt₂Cl and Al₂Et₃Cl₃.

In some embodiments, external electron-donor compounds are selected from the group consisting of silicon compounds, ethers, esters, amines, heterocyclic compounds, ketones, and 1,3-diethers. In some embodiments, the ester is ethyl 4-ethoxybenzoate. In some embodiments, the heterocyclic compound is 2,2,6,6-tetramethyl piperidine. In some embodiments, the silicon compounds have formula Rₐ⁵R_{b}⁶Si(OR⁷)_{c}, wherein a and b are integers from 0 to 2, c is an integer from 1 to 3, and the sum (a+b+c) is 4; R⁵, R⁶, and R⁷ are alkyl, cycloalkyl, or aryl radicals with 1-18 carbon atoms optionally containing heteroatoms. In some embodiments, the silicon compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and 1,1,1,trifluoropropyl-methyl-dimethoxysilane. In some embodiments, the amount of external electron donor compound provides a molar ratio between the organo-aluminum compound and the electron donor compound of from 0.1 to 500; alternatively from 1 to 100; alternatively from 2 to 50.

In some embodiments, the polymerization process is continuous or batch. In some embodiments, the polymerization process is operated in gas phase, in liquid phase, or by mixed liquid-gas techniques. In some embodiments, the liquid phase is operated in the presence of an inert diluent. In some embodiments, the liquid phase is operated in the absence of an inert diluent. In some embodiments, the polymerization is carried out in gas phase in three reactors, with a reactor for each component of the composition. In some embodiments and in the first two reactors, components a) and b) respectively are obtained while component c) is obtained in the third and last reactor.

In some embodiments, the polymerization temperature is from 20 to 100° C. In some embodiments, the polymerization pressure is atmospheric or higher.

In some embodiments, the molecular weight is regulated. In some embodiments, the molecular weight regulator is hydrogen.

In some embodiments, the propylene polymer composition is further made from or containing additives. In some embodiments, the additives are selected from the group consisting of nucleating agents, clarifying agents, and processing aids.

In some embodiments, the propylene polymer composition has a number of gels No (>0.1 mm) of less than 250; alternatively less than 150.

In some embodiments, the propylene polymer composition is used for the production of films. In some embodiments, cast or BOPP film mono or multilayer have a layer made from or containing the propylene polymer composition.

### Examples

The following examples are given for illustration without limiting purpose.

The data relating to the polymeric materials and the films of the examples are determined by the methods reported below.

### Melting and Crystallization Temperature (ISO 11357-2013)

Determined by differential scanning calorimetry (DSC) according to ISO 11357-20133, at scanning rate of 20° C./min both in cooling and heating, on a sample of weight between 5 and 7 mg., under inert N2 flow. The instrument was calibrated with Indium.

### Melt Flow Rate (MFR)

Determined according to ISO 1133, 230° C., 2.16 kg.

### Solubility in Xylene at 25° C.

Solubility in xylene at 25° C.: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C., without stirring during the first 20 minutes and maintained at 25° C., with stirring for the last 10 minutes. The formed solid was filtered on quick filtering paper (for example, Whatman filtering paper grade 4 or 541). 100 ml of the filtered solution (S1) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(tot) and XSA values were experimentally determined. The fraction of component (B) soluble in xylene at 25° C. (XSB) was calculated from the formula:

$$XS = W ( A ) \times ( {XS}_{A} ) + W ( B ) \times ( {XS}_{B} )$$

wherein W(A) and W(B) are the relative amounts of components (A) and (B), respectively, and W(A)+W(B)=1.

### Determination of 1-Hexene Content by NMR

¹³C NMR spectra are acquired on an AV-600 spectrometer, operating at 150.91 MHz in the Fourier transform mode at 120° C. The peak of the propylene CH was used as internal standard at 28.83. The ¹³C NMR spectrum was acquired using the following parameters:

| Spectral width (SW) | 60 | ppm |
|---|---|---|
| Spectrum center (O1) | 30 | ppm |
| Decoupling sequence | WALTZ 65_64pl | |
| Pulse program | ZGPG | |
| Pulse Length (P1) | for 90° | |
| Total number of | 32K | |
| points (TD) | | |
| Relaxation Delay | 15 | s |

| | |
|---|---|
| Number of transients | 1500 |

The total amount of 1-hexene as molar percent was calculated from diad using the following relations:

$$[ P ] = PP + 0.5 PH$$

$$[ H ] = HH + 0.5 PH$$

Assignments of the ¹³C NMR spectrum of propylene/1-hexene copolymers were calculated according to the following table:

| Area | Chemical Shift | Assignments | Sequence |
|---|---|---|---|
| 1 | 46.93-46.00 | S_{αα} | PP |
| 2 | 44.50-43.82 | S_{αα} | PH |
| 3 | 41.34-4.23 | S_{αα} | HH |
| 4 | 38.00-37.40 | S_{αγ} + S_{αδ} | PE |
| 5 | 35.70-35.0 | 4B₄ | H |
| 6 | 35.00-34.53 | S_{αγ} + S_{αδ} | HE |
| 7 | 33.75 33.20 | CH | H |
| 8 | 33.24 | T_{δδ} | EPE |
| 9 | 30.92 | T_{βδ} | PPE |
| 10 | 30.76 | S_{γγ} | XEEX |
| 11 | 30.35 | S_{γδ} | XEEE |
| 12 | 29.95 | S_{δδ} | EEE |
| 13 | 29.35 | 3B₄ | H |
| 14 | 28.94-28.38 | CH | P |
| 15 | 27.43-27.27 | S_{βδ} | XEE |
| 16 | 24.67-24.53 | S_{ββ} | XEX |
| 17 | 23.44-23.35 | 2B₄ | H |
| 18 | 21.80-19.90 | CH₃ | P |
| 19 | 14.22 | CH₃ | H |

### Ethylene (C2) Content

### ¹³C NMR of Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

$$PPP = 100 {T}_{ββ} / S \qquad PPE = 100 {T}_{βδ} / S \qquad EPE = 100 {T}_{δδ} / S$$

$$PEP = 100 {S}_{ββ} / S \qquad PEE = 100 {S}_{βδ} / S \qquad EEE = 100 ( 0.25 {S}_{γδ} + 0.5 {S}_{δδ} ) / S$$

$$S = {T}_{ββ} + {T}_{βδ} + {T}_{δδ} + {S}_{ββ} + {S}_{βδ} + 0.25 {S}_{γδ} + 0.5 {S}_{δδ}$$

The molar percentage of ethylene content was evaluated using the following equation:

$$E \% mol = 100 * [ PEP + PEE + EEE ]$$

The weight percentage of ethylene content was evaluated using the following equation:

$$E \% wt . = \frac{100 * E \% mol * {MW}_{E}}{E \% mol * {MW}_{E} + P \% mol * {MW}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of propylene sequences was calculated as mm content from the ratio of the PPP mmT_{ββ} (28.90-29.65 ppm) and the whole T_{ββ} (29.80-28.37 ppm).

### 1-Hexene and Ethylene Content:

Determined by ¹³C-NMR spectroscopy in terpolymers:

NMR analysis. ¹³C NMR spectra were acquired on an AV-600 spectrometer, operating at 150.91 MHz in the Fourier transform mode at 120° C. The peak of the propylene CH was used as internal standard at 28.83. The ¹³C NMR spectrum was acquired using the following parameters:
Spectral width (SW) 60 ppm
Spectrum center (O1) 30 ppm
Decoupling sequence WALTZ 65_64pl
Pulse program⁽¹⁾ ZGPG
Pulse Length (P1)^{(2)\} for 90°
Total number of points (TD) 32K
Relaxation Delay⁽²⁾ 15 s
Number of transients⁽³⁾ 1500

The total amount of 1-hexene and ethylene as molar percent was calculated from diad using the following relations:

$$[ P ] = PP + 0.5 PH + 0.5 PE$$

$$[ H ] = HH + 0.5 PH$$

$$[ E ] = EE + 0.5 PE$$

Assignments of the ¹³C NMR spectrum of propylene/1-hexene/ethylene copolymers were calculated according to the following table:

| Area | Chemical Shift | Assignments | Sequence |
|---|---|---|---|
| 1 | 46.93-46.00 | S_{αα} | PP |
| 2 | 44.50-43.82 | S_{αα} | PH |
| 3 | 41.34-4.23 | S_{αα} | HH |
| 4 | 38.00-37.40 | S_{αγ} + S_{αδ} | PE |
| 5 | 35.70-35.0 | 4B₄ | H |
| 6 | 35.00-34.53 | S_{αγ} + S_{αδ} | HE |
| 7 | 33.75 33.20 | CH | H |
| 8 | 33.24 | T_{δδ} | EPE |
| 9 | 30.92 | T_{βδ} | PPE |
| 10 | 30.76 | S_{γγ} | XEEX |
| 11 | 30.35 | S_{γδ} | XEEE |
| 12 | 29.95 | S_{δδ} | EEE |
| 13 | 29.35 | 3B₄ | H |
| 14 | 28.94-28.38 | CH | P |
| 15 | 27.43-27.27 | S_{βδ} | XEE |
| 16 | 24.67-24.53 | S_{ββ} | XEX |
| 17 | 23.44-23.35 | 2B₄ | H |
| 18 | 21.80-19.90 | CH₃ | P |
| 19 | 14.22 | CH₃ | H |

The 1-hexene contents of component b were calculated from the 1-hexene total content of the composition by using the formula C6ₜₒₜ=C6ₐxWₐ+C6bxWb, wherein C6 is the 1-hexene content and Wa and Wb are the amount of components a and b.

### Seal Initiation Temperature (SIT)

### Preparation of the Film Specimens

Some films with a thickness of 50 μm were prepared by extruding each test composition in a single screw Collin extruder (length/diameter ratio of screw 1:25) at a film drawing speed of 7 m/min and a melt temperature of 210-250° C. Each resulting film was superimposed on a 1000 μm thick film of a propylene homopolymer, having a xylene insoluble fraction of 97 wt % and a MFR L of 2 g/10 min. The superimposed films were bonded to each other in a Carver press at 200° C. under a 9000 kg load, which was maintained for 5 minutes. The resulting laminates were stretched longitudinally and transversally, that is, biaxially, by a factor of 7 with a Karo 4 Brueckener film stretcher at 160° C., thereby obtaining a 20 μm thick film (18 μm homopolymer+2 μm test). Determination of the SIT.

Film Strips, 6 cm wide and 35 cm length, were cut from the center of the BOPP film. The film was superimposed with a BOPP film made of PP homopolymer. The superimposed specimens were sealed along a 2 cm sides with a Brugger Feinmechanik Sealer, model HSG-ETK 745. Sealing time was 5 seconds at a pressure of 0.14 MPa (20 psi). The starting sealing temperature was from about 10° C. less than the melting temperature of the test composition. The sealed strip was cut into 6 specimens 15 mm wide long enough to be held in the tensile tester grips. The seal strength was tested at a load cell capacity 100 N, cross speed 100 mm/min, and grip distance 50 mm. The results were expressed as the average of maximum seal strength (N). The unsealed ends were attached to an Instron machine, wherein the sample specimens were tested at a traction speed of 50 mm/min.

The test was repeated by changing the temperature as follows:

If seal strength <1.5 N, then increase the temperature.

If seal strength >1.5 N, then decrease the temperature.

Temperature variation was adjusted stepwise. If seal strength was close to target, steps of 1° C. were selected. If the strength was far from target, steps of 2° C. were selected.

The target seal strength (SIT) was defined as the lowest temperature at which a seal strength higher or equal to 1.5 N was achieved

### Preparation of the Copolymer

### Catalyst System

### Procedure for the Preparation of the Spherical Adduct

Microspheroidal MgCl₂·pC₂H₅OH adduct was prepared according to the method described in Comparative Example 5 of Patent Cooperation Treaty Publication No. WO98/44009, with the difference that BiCl₃ in a powder form and in an amount of 3 mol % with respect to the magnesium was added before feeding the oil.

### Procedure for the Preparation of the Solid Catalyst Component

Solid catalyst component was prepared according to Example 1 of European Patent No. EP 728769 with the following differences:

The second and third titanations were carried out at 110° C. instead of 120° C.

MgCl2.3 C2H50H in the form of spherical solid particles with a maximum diameter less than or equal to 65 micron instead of 50 micron was used.

### Catalyst System and Prepolymerization Treatment

The solid catalyst component was contacted at 15° C. for about 6 minutes with aluminum triethyl (TEAL) and dicyclopentyl dimethoxy silane (DCPMS) as external donor.

The catalyst system was then subjected to prepolymerization by suspending the catalyst system in liquid propylene at 20° C. for about 20 minutes, before introducing the catalyst system into the polymerization reactor.

### Polymerization

Into a first gas phase polymerization reactor, a propylene 1-hexene copolymer (component (a)) was produced by feeding, in a continuous and constant flow, the prepolymerized catalyst system, hydrogen (used as molecular weight regulator), propylene, and 1-hexene in the gas state. The polypropylene copolymer produced in the first reactor was discharged, in a continuous flow, and introduced, in a continuous flow, into a second gas phase polymerization reactor, together with quantitatively constant flows of hydrogen, 1-hexene, and propylene in the gas state.

The polypropylene copolymer produced in the second reactor was discharged, in a continuous flow, and, after having been purged of unreacted monomers, was introduced, in a continuous flow, into a third gas phase polymerization reactor, together with quantitatively constant flows of hydrogen, 1-hexene, and propylene in the gas state.

The polymerization conditions are reported in Table 1.

TABLE 1

| | | Ex1 | Ex2 | Comp Ex 3 | Comp Ex 4 |
|---|---|---|---|---|---|
| catalyst feed | g/h | 16 | 16 | 17.5 | 16 |
| TEAL/solid catalyst component | g/g | 3 | 3 | 3 | 3 |
| weight ratio | | | | | |
| TEAL/D donor weight ratio | g/g | 11 | 11 | 10 | 10 |
| Prepolymerization | | | | | |
| temperature | ° C. | 20 | 20 | 20 | 20 |
| Residence time | | 33 | 33 | 33 | 33 |
| First gas phase reactor | | | | | |
| Polymerization temperature | ° C. | 72 | 72 | 72 | 72 |
| Pressure | barg | 15 | 15 | 15 | 15 |
| H2/C3 | mol/mol | 0.0005 | 0.0005 | 0.0008 | 0.0005 |
| C6/C6 + C3 | mol/mol | 0.034 | 0.032 | 0.037 | 0.044 |
| Second gas phase reactor | | | | | |
| Polymerization temperature | ° C. | 72 | 72 | 72 | 72 |
| Pressure | barg | 15 | 15 | 15 | 15 |
| H2/C3 | mol/mol | 0.009 | 0.009 | 0.016 | 0.014 |
| C6/C6 + C3 | mol/mol | 0.069 | 0.072 | 0.054 | 0.058 |
| C2/C2 + C3 | mol/mol | 0.019 | 0.018 | 0.015 | 0.014 |
| Third gas phase reactor | | | | | |
| Polymerization temperature | ° C. | 65 | 65 | 65 | 65 |
| Pressure | barg | 14 | 14 | 14 | 14 |
| H2/C3 | mol/mol | 0.018 | 0.018 | 0.016 | 0.019 |
| C2/C2 + C3 | mol/mol | 0.053 | 0.063 | 0.038 | 0.032 |

C3 = propylene;
C6 = 1-hexene;
C2 ethylene;
H2 = hydrogen

The resulting polymer obtained according to Table 1 was further made from or containing 0.05% Irg. 1010; 0.1% Irg. 168, and 0.05% CaSt, then pelletized. The features of the compositions are reported in Table 2.

TABLE 2

| | | Ex1 | Ex2 | Comp Ex 3 | Comp Ex 4 |
|---|---|---|---|---|---|
| component a) | | | | | |
| MFR | g/10′ | 6.5 | 6.4 | 6.2 | 5.8 |
| split | wt % | 31.5 | 31.5 | 30 | 25 |
| C6- content | wt % | 7 | 6.6 | 7 | 7.1 |
| Xylene soluble | Wt % | 12.3 | 11.4 | 13.0 | 13.6 |
| 25° C. | | | | | |
| component b) | | | | | |
| MFR a) + b) | gr/10′ | 6.0 | 5.3- | 5.8 | 5.6 |
| C6 content* | wt % | 8.5 | 8.8- | 9.0 | 8.6 |
| C2 content* | wt % | 1.6 | 1.5 | 0.9 | 1.5 |
| split | | 38.5 | 38.5- | 30 | 30 |
| Xylene soluble | Wt % | 21.0 | 20.5 | nm | nm |
| 25° C. (a + b) | | | | | |
| component c) | | | | | |
| C2 content* | Wt % | 5.2 | 7.5 | 2.9 | 3.0 |
| split | Wt % | 30 | 30 | 45 | 45 |
| | Wt % | | — | | |
| composition | | | | | |
| MFR tot | g/10′ | 5.2 | 4.8 | 5.1 | 5.7 |
| Xylene Soluble | wt % | 26.1 | 25.7 | 17.8 | 16.8 |
| 25° C. | | | | | |
| Tm | ° C. | 127.2 | 127.9 | 133.6 | 133.4 |
| Tc | ° C. | 82 | 8 | 89.4 | 90.5 |
| haze | % | 0.76 | 0.61 | 0.67 | 0.47 |
| SIT on BOPP | ° C. | 80 | 81 | 90 | 91 |
| film (RDM) | | | | | |

C3 = propylene;
C6 = 1-hexene;
C2 ethylene;
*calculated by using the formula Ytot = XaYa + XbYb wherein Y is the comonomer content and Xa and Xb are the splits (Xa + Xb = 1).

What is claimed is:

1. A propylene polymer composition comprising:
a) from 20 wt % to 44 wt % of a propylene 1-hexene copolymer, containing from 5.0 wt % to 8.3 wt % of 1-hexene derived units, measured by ¹³C NMR, and having a Melt Flow Rate (MFR, measured according to ISO 1133, 230° C./2.16 kg, that is, at 230° C., with a load of 2.16 kg) from 3.5 to 8.5 g/10 min;
b) from 25 wt % to 45 wt % of a propylene 1-hexene ethylene terpolymer, containing from 7.2 to 12.0% by weight, of 1-hexene derived units, measured by ¹³C NMR and from 0.5 to 2.5 wt % of ethylene derived units, measured by ¹³C NMR,
wherein the Melt Flow Rate (MFR, measured according to ISO 1133, 230° C./2.16 kg, that is, at 230° C. with a load of 2.16 kg) of components a)+b) is from 3.5 to 8.5 g/10 min; and
c) from 25 wt % to 50 wt % of a propylene ethylene copolymer, containing from 3.5 wt % to 8.7 wt % of ethylene derived units, measured by ¹³C NMR,
wherein the Melt Flow Rate (MFR, measured according to ISO 1133, 230° C./2.16 kg, that is, at 230° C., with a load of 2.16 kg) of components a)+b)+c) is from 3.5 to 12.0 g/10 min;
the sum of the amount of a), b) and c) being 100;
wherein:
i) the xylene soluble content at 25° C. of the propylene polymer composition ranges from 19.0 wt % to 35.3 wt %; and
ii) the melting point of the propylene polymer composition ranges from 122° C. to 132° C.

2. The propylene polymer composition according to claim 1, wherein component a) ranges from −27 wt % to 40 wt %; component b) ranges from −35 wt % to 40 wt %; and component c) ranges from 27 wt % to 40 wt %.

3. The propylene polymer composition according to claim 2, wherein
component a) ranges from 29 wt % to 35 wt %; component b) ranges from 36 wt % to 39 wt %; and component c) ranges from 29 wt % to 35 wt %.

4. The propylene polymer composition according to claim 1, wherein component a) contains from 6.3 wt % to 7.8 wt % of 1-hexene derived units.

5. The propylene polymer composition according to claim 1, wherein component b) contains from 7.5 wt % to 9.5 wt % of 1-hexene derived units and from 0.7 wt % to 2.2 wt % of ethylene derived units.

6. The propylene polymer composition according to claim 1, wherein component c) contains from 4.5 wt % to 8.4 wt % of ethylene derived units.

7. The propylene polymer composition according to claim 1, wherein component a) contains from 6.5 wt % to 7.4 wt % of 1-hexene derived units.

8. The propylene polymer composition according to claim 1, wherein component b) contains from 8.2 wt % to 9.1 wt % of 1-hexene derived units and from 0.8 wt % to 2.0 wt % of ethylene derived units.

9. The propylene polymer composition according to claim 1, wherein component c) contains from 4.8 wt % to 8.1 wt % of ethylene derived units.

10. The propylene polymer composition according to claim 1, wherein the melting point of the propylene polymer composition ranges from 125° C. to 131° C.

11. The propylene polymer composition according to claim 1, wherein the xylene soluble content at 25° C. of the propylene polymer composition ranges from 18.3 wt % to 30.1 wt %.

12. The propylene polymer composition according to claim 1, wherein the xylene soluble content at 25° C. of the composition ranges from 22.1 wt % to 28.3 wt %.

13. A film comprising the propylene polymer composition according to claim 1.

14. The film of claim 13 being a cast film.

15. The film of claim 13 being a BOPP film.
